(19) United States
(12) Patent Application Publication
(10) Pub. No.: US 2025/0038427 A1
(43) Pub. Date: Jan. 30, 2025

(54) DUAL CIRCULARLY POLARIZED ANTENNA AND RELATED SYSTEMS AND METHODS

(71) Applicant: Analog Devices International Unlimited Company, Co. Limerick (IE)

(72) Inventors: Ahmed A. Sakr, Cairo (EG); Islam A. Eshrah, Cairo (EG)

(21) Appl. No.: 18/630,764

(22) Filed: Apr. 9, 2024

Related U.S. Application Data
(60) Provisional application No. 63/515,555, filed on Jul. 25, 2023.

(51) Int. Cl. H01Q 21/26

(52) U.S. Cl. CPC H01Q 21/26

(57) ABSTRACT

Aspects of this disclosure relate to an antenna cell. An antenna cell may include a first circularly polarized dipole antenna that includes a first pair of differently fed conductive elements, the first circularly polarized dipole antenna being right hand circularly polarized. The antenna cell may include a second circularly polarized dipole antenna that includes a second pair of differently fed conductive elements, the second circularly polarized dipole antenna being left hand circularly polarized. The first circularly polarized dipole antenna and the second circularly polarized dipole antenna may be geometrically orthogonal and configured to radiate concurrently. The first circularly polarized dipole antenna may be positioned adjacent to the second circularly polarized dipole antenna.

### CROSS REFERENCE TO RELATED APPLICATIONS

Any and all applications for which a foreign or domestic priority claim is identified in the Application Data Sheet as filed with the present application are hereby incorporated by reference under 37 C.F.R. § 1.57. This application claims the benefit of priority of U.S. Provisional Application No. 63/515,555, filed Jul. 25, 2023 and titled “DIFFERENTIALLY-FED SEQUENTIALLY ROTATED DIPOLES FOR DUAL CIRCULARLY-POLARIZED HIGHLY-ISOLATED ANTENNAS,” the disclosure of which is hereby incorporated by reference in its entirety and for all purposes. The present application relates to U. S. Application No. ______[Attorney Docket No. ADIAD.054A1], titled “ANTENNA ARRAY WITH DUAL CIRCULARLY POLARIZED ANTENNAS,” filed on even date herewith, the entire disclosure of which is hereby incorporated by reference herein.

### BACKGROUND

### Technical Field

The disclosed technology generally relates to antennas. More specifically, embodiments of this disclosure relate to circularly polarized antennas.

### Description of Related Technology

An antenna can transmit and/or receive radio frequency (RF) signals that propagate as electromagnetic waves through space. A radio transmitter can provide a signal to an antenna, and the antenna can radiate energy from the signal as radio waves. An antenna can receive an RF signal. The received RF signal can be processed by a radio receiver. Antennas can be used in a variety of wireless communication applications. Certain antennas can be circularly polarized and radiate an electric field that rotates with time and space.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

One aspect of this disclosure is an antenna array that includes a first circularly polarized dipole antenna. The first circularly polarized antenna includes a first pair of conductive elements. The antenna array includes a second circularly polarized dipole antenna. The second circularly polarized dipole antenna includes a second pair conductive elements, the second pair of conductive elements being geometrically orthogonal to the first pair of conductive elements. The antenna array includes a beamformer integrated circuit configured to drive the first circularly polarized dipole antenna such that the first circularly polarized dipole antenna transmits a first radio frequency signal while the second circularly polarized dipole antenna receives a second radio frequency signal, the first radio frequency signal having a different polarization and being in a different frequency band than the second radio frequency signal.

The beamformer integrated circuit can be connected to the first circularly polarized dipole antenna by way of a single feedline. The first pair of conductive elements can be connected to each other by a half wavelength delay line.

The antenna array can include a second beamformer integrated circuit connected to the second circularly polarized dipole antenna by way of differential feedlines.

The antenna array can include a third circularly polarized dipole antenna. The third circularly polarized dipole antenna can include a third pair of conductive elements that are geometrically orthogonal to the second pair of conductive elements. The third circularly polarized dipole antenna can be positioned adjacent an opposite end of the second circularly polarized dipole antenna than the first circularly polarized dipole antenna.

The beamformer integrated circuit can connected to the first circularly polarized dipole antenna by way of differential feedlines.

The first circularly polarized dipole antenna can be oriented at angle of approximately 45 degrees relative to an edge of the beamformer integrated circuit.

The first pair of conductive elements can include microstrips.

The first radio frequency signal and the second radio frequency can have respective frequencies in a range from 15 gigahertz to 100 gigahertz.

The antenna array can include a plurality of additional circularly polarized dipole antennas connected to the beamformer integrated circuit. The plurality of additional circularly polarized dipole antennas can have a same polarization as the first circularly polarized dipole antenna. The beamformer integrated circuit can be configured to concurrently drive the plurality of additional circularly polarized dipole antennas and the first circularly polarized dipole antenna.

Another aspect of this disclosure is an antenna array that includes a plurality of first circularly polarized antennas, a first beamformer integrated circuit connected to the first circularly polarized antennas, and a plurality of second circularly polarized antennas. The second circularly polarized antennas has a different polarization than the first circularly polarized antennas and the antenna array includes twice as many first circularly polarized antennas as second circularly polarized antennas. The antenna array includes a second beamformer integrated circuit connected to the second circularly polarized antennas. The antenna array is configured for full duplex communication using at least the first circularly polarized antennas and the second circularly polarized antennas.

The first circularly polarized antennas can be each connected to the first beamformer integrated circuit by a single feedline. The second circularly polarized antennas can be each connected to the second beamformer by differential feedlines.

The first beamformer integrated circuit can be a transmit beamformer integrated circuit. The second beamformer integrated circuit can be a receive integrated circuit.

The first beamformer integrated circuit can be a receive beamformer integrated circuit. The second beamformer integrated circuit can be a transmit integrated circuit.

The first circularly polarized antennas can be associated with a higher frequency band than the second circularly polarized antennas.

The first circularly polarized antennas can include a first dipole antenna, and the second circularly polarized antenna can include a second dipole antenna that is geometrically orthogonal to the first dipole antenna.

The first dipole antenna can include microstrips.

Another aspect of this disclosure is a method of full duplex wireless communication. The method incudes transmitting a first radio frequency signal from a first circularly polarized dipole antenna of an antenna array, and concurrent with the transmitting, receiving a second radio frequency signal with a second circularly polarized dipole antenna of the antenna array. The second circularly polarized dipole antenna has a different polarization than the first circularly polarized dipole antenna. The first radio frequency signal is in a different frequency band than the second radio frequency signal.

The first circularly polarized dipole antenna can be geometrically orthogonal with the second circularly polarized dipole antenna.

The first circularly polarized dipole antenna can be connected to a transmit beamformer integrated circuit of the antenna array by a single feedline. The first radio frequency signal can be in a higher frequency band than the second radio frequency signal.

The second radio frequency signal can be received from a satellite.

Another aspect of this disclosure is an antenna cell that includes a first circularly polarized dipole antenna. The first circularly polarized dipole antenna includes a first pair of differently fed conductive elements. The first circularly polarized dipole antenna being right hand circularly polarized. The antenna cell includes a second circularly polarized dipole antenna. The second circularly polarized dipole antenna includes a second pair of differently fed conductive elements. The second circularly polarized dipole antenna being left hand circularly polarized. The first circularly polarized dipole antenna and the second circularly polarized dipole antenna are geometrically orthogonal and configured to operate concurrently. The first circularly polarized dipole antenna is positioned adjacent to the second circularly polarized dipole antenna.

The first circularly polarized dipole antenna and the second circularly polarized dipole antenna can be configured to receive concurrently.

The first circularly polarized dipole antenna can be configured to transmit a right hand circularly polarized signal while the second circularly polarized dipole antenna transmits a left hand circularly polarized signal.

The first circularly polarized dipole antenna and the second circularly polarized dipole antenna operate in a common frequency band.

The first circularly polarized dipole antenna and the second circularly polarized dipole antenna can each have an axial ratio of no greater than 3 decibels in the common frequency band.

A conductive element of the first pair of differentially fed conductive elements can be connected to each of the conductive elements of the second pair of differentially fed conductive elements by way of a respective quarter wavelength delay line.

The antenna cell can further include 3 quarter wavelength delay lines connecting respective adjacent conductive elements of the first and second pairs of differentially fed conductive elements.

Another aspect of this disclosure is an antenna cell that includes four sequentially rotated conductive elements. The four sequentially rotated conductive elements include a first pair of conductive elements forming a first dipole antenna and a second pair of conductive elements forming a second dipole antenna, the first dipole antenna having a right hand circular polarization, and the second dipole antenna having a left hand circular polarization. The antenna cell includes three quarter wavelength delay lines that connect respective adjacent conductive elements of the four sequentially rotated conductive elements such that the first dipole antenna and the second dipole antenna are each differentially fed.

The first dipole antenna and the second dipole antenna can operate in a common frequency band.

The first dipole antenna and the second dipole antenna can each have an axial ratio of no greater than 3 decibels in the common frequency band.

The antenna cell can be configured to concurrently receive a left hand circularly polarized signal and a right hand circularly polarized signal.

The antenna cell can be configured to concurrently transmit a left hand circularly polarized signal and a right hand circularly polarized signal.

The four sequentially rotated conductive elements can include microstrips.

The antenna cell can further include a first port configured to feed a left hand circularly polarized signal, in which the first port is connected to a conductive element of the first pair of conductive elements. The antenna cell can further include a second port configured to feed a right hand circularly polarized signal, in which the second port is connected to a conductive element of the second pair of conductive elements.

Another aspect of this disclosure is a method of wireless communication. The method includes transmitting a right hand circularly polarized signal from a first dipole antenna of an antenna cell, and concurrent with the transmitting right hand circularly polarized signal, transmitting a left hand circularly polarized signal from a second dipole antenna of the antenna cell. The antenna cell includes four sequentially rotated conductive elements. The four sequentially rotated conductive elements include a first pair of conductive elements forming the first dipole antenna and a second pair of conductive elements forming the second dipole antenna. The antenna cell includes three quarter wavelength delay lines that connect respective adjacent conductive elements of the four sequentially rotated conductive elements such that the first dipole antenna and the second dipole antenna are each differentially fed.

The first dipole antenna and the second dipole antenna can operate in a common frequency band.

The four sequentially rotated conductive elements can include microstrips.

The right hand circularly polarized signal and the left hand circularly polarized signal can each have a frequency in a range from 15 gigahertz to 100 gigahertz.

The left hand circularly polarized signal can be in either the K band or the KA band.

The right hand circularly polarized signal can be transmitted to a satellite.

For purposes of summarizing the disclosure, certain aspects, advantages and novel features of the innovations have been described herein. It is to be understood that not necessarily all such advantages may be achieved in accordance with any particular embodiment. Thus, the innovations may be embodied or carried out in a manner that achieves or optimizes one advantage or group of advantages as taught herein without necessarily achieving other advantages as may be taught or suggested herein.

### BRIEF DESCRIPTION OF THE DRAWINGS

Embodiments of this disclosure will be described, by way of non-limiting example, with reference to the accompanying drawings.

FIG. 1 is a schematic diagram illustrating coupling in a dual-polarized communication system.

FIG. 2 illustrates one example of the use of a dual-polarized communication device in a satellite communications network.

FIG. 3 illustrates a schematic layout diagram of a dual-polarized communication system according to an embodiment.

FIGS. 4A-4C illustrate different configurations for a circularly polarized antenna array, according to various embodiments.

FIGS. 5A and 5B illustrate further configurations for a circularly polarized antenna array, according to various embodiments.

FIGS. 6A-6C are example graphs illustrating various attributes of a circularly polarized antenna array in accordance with an embodiment.

FIGS. 7A and 7B illustrate a single element antenna cell according to an embodiment.

FIGS. 8A and 8B are example graphs illustrating various attributes of a single element antenna cell according to an embodiment.

### DETAILED DESCRIPTION OF CERTAIN EMBODIMENTS

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the illustrated elements. Further, some embodiments can incorporate any suitable combination of features from two or more drawings.

Aspects of this disclosure relate to a dual circularly polarized antenna with high isolation and controllable polarization with a simplified geometry suitable for phased array boards. Embodiments of this disclosure relate to an antenna array with receive antennas and transmit antennas, where dipoles of the receive antennas are geometrically orthogonal to dipoles of the transmit antennas.

For a dual circularly polarized antenna, achieving good isolation between the orthogonal polarizations when they share a same aperture and keeping a good axial ratio is a significant technical challenge. A technical challenge is not only to achieve these specifications, but to also use a relatively simple integrated and compact design that is suitable for phased arrays with aggressive scanning possibilities.

This disclosure provides orthogonally rotated and integrated dipoles with differential excitation. Such dipoles, along with antenna array arrangements, can achieve desirable isolation between orthogonal polarizations and also between co-polarizations within the array for a relatively stable antenna impedance with a scan.

In certain applications, circularly polarized antennas disclosed herein can be used for relatively short distance wireless links at millimeter wave frequencies. For instance, circularly polarized antennas disclosed herein can be used for wireless links at frequencies in a range from 15 gigahertz (GHz) to 100 GHz. Circularly polarized antenna elements disclosed herein can be used for wireless communications between a master module and a slave module. Such wireless communications can be full duplex communications.

Antennas disclosed herein can be used for wireless communications in wide variety of applications, including but not limited to communications with robots or portions thereof such as robotic arms, communications with rotating cameras, other industrial applications, communications between train wagons, communications between a vehicle and a trailer, communications between a vehicle and a rotating camera, other vehicular and/or automotive applications, or the like.

Polarization is the property of an electromagnetic (EM) wave that defines the way an electric field vector of the EM wave behaves with respect to time. Wireless communication systems often employ linearly or circularly polarized EM waves. In active electronically scanned arrays (AESAs), often used in communication systems (e.g., fifth generation (5G) and/or sixth generation (6G) communication systems), dual-polarized systems can be used to increase and/or maximize the supported number of streams per array area. When dual-polarization is utilized, isolation between array polarizations can be desirable.

The coupling between polarizations in a dual-polarization system can have detrimental effects on the performance of the dual-polarization system. For example, an impedance (Z) of an antenna, at an output of a power amplifier (PA) on the beamformer integrated circuits (BFICs) and/or other circuitry used to operate the dual-polarization system, can vary depending on a relative magnitude and phase between the polarizations. The varying impendence can result in load-pulling the PA driving the dual-polarization system as the impedance varies for different beam positions under element phasing. As another example, the cross-polarization discrimination (XPD) may be relatively low, reducing a signal-to-noise ratio (SNR). Reducing the SNR can limit the modulation scheme.

Antennas with single-feed polarizations can often have approximately 15 decibels (dB) of isolation between ports. Embodiments disclosed herein can increase the isolation between ports in a dual-polarization system.

For circular polarization, a radiated electric field rotates with time and space. Both x and y lateral components of the radiated electric field can be present. The radiated electric field ε can be represented by Equation 1:

$$ℰ ( 𝓏 ; t ) = {E}_{0} ( \hat{x} cos ( ω t - {k}_{0} 𝓏 ) \pm \hat{y} sin ( ω t - {k}_{0} 𝓏 ) ) \qquad ( Equation 1 )$$

In Equation 1, k0 represents wave number. For right hand circular polarization (RHCP), the y component of the electric field lags the x component. For left hand circular polarization (LHCP), the x component of the electric field lags the y component. Regardless of rotation of the electric field, an antenna can still receive a good signal.

For circular polarization, an axial ratio AR can be represented by Equation 2 in which a is a major radius and b is a minor radius of an elliptical envelope of the radiated electric field.

$$A R = 20 log \frac{a}{b} \qquad ( Equation 2 )$$

The axial ratio can represent a quality of circular polarization. The smaller the axial ratio AR, the more circularly a wave is polarized. An axial ratio AR of 0 dB can represent the best circular polarization.

For circularly polarized antennas, both lateral components of EM waves are typically excited with a 90° phase shift. Wideband designs can involve exciting both lateral components of EM waves to generate the desired circular polarization. However, dual-fed antennas (e.g., 0°, −90° excitation with a T-splitter and a delay line) that satisfy wideband specifications can generate radiation that is usually tilted from a broadside direction. Also, the radiation characteristics (e.g., beam peak direction and axial ratio) can be impacted by the surroundings, such as ground size.

For a dual circularly polarized antenna, achieving a desired isolation between the orthogonal polarizations can be difficult when each polarization shares the same aperture. Further, it can be difficult to maintain a desired and axial ratio. It can be further challenging to achieve these, and other desired effects, while using a simple integrated and compact design, suitable for phased arrays with aggressive scanning possibilities. Disclosed herein are dual circularly polarized antennas with orthogonally rotated and integrated dipoles that can utilize relatively simple differential excitation. Also disclosed herein, are arrangements for antenna arrays that can improve isolation between orthogonal polarizations and improve isolation between co-polarizations within the antenna array, resulting in a relatively stable antenna impedance during a beam scan.

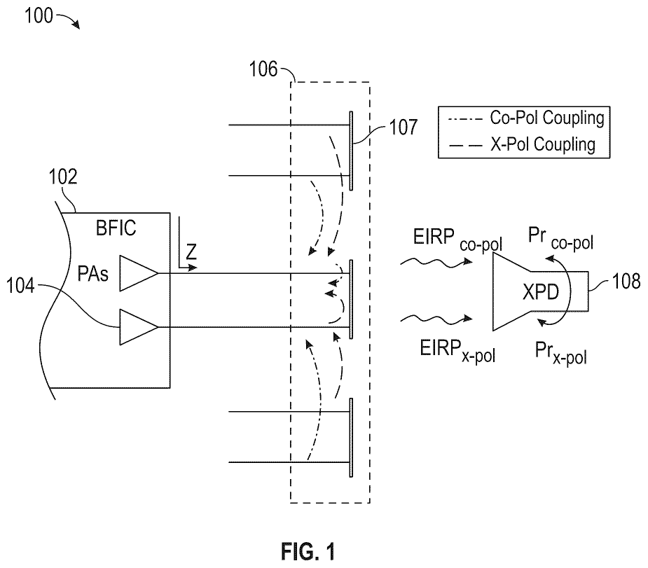

FIG. 1 is a schematic diagram illustrating coupling in a dual-polarized communication system 100. As illustrated, the dual-polarized communication system 100 can include co-polarization (co-pol) coupling and cross-polarization (x-pol) coupling. The dual-polarized communication system 100 can include a beamformer circuit 102 that includes power amplifiers (PAs) 104, an antenna array 106 with dual-polarized antennas 107, and a receiving system 108. The beamformer circuit 102 can include circuitry for creating and controlling beamformed signals for the antenna array 106. For example, the beamformer circuit 102 can include various PAs 104, variable gain amplifiers, phase-shifters, low noise amplifiers, the like or any combination thereof. As illustrated, the beamformer circuit 102 is a BFIC. The PAs 104 can feed the beamformed signal into feeds of the dual-polarized antennas 107 in the antenna array 106. The antenna array 106 can transmit a signal to the to the receiving system 108, which can be a receiving antenna or antenna system, such as on a communications satellite or another device.

Co-pol coupling can refer the coupling effects experienced by feeds of the dual-polarized antennas 107 used for the same polarization. FIG. 1 illustrates an example configuration of co-pol coupling. Co-pol coupling may be determined by the beam position of the beamformed signal fed to the antenna array 106. As such, in some implementations the co-pol coupling may be accounted for in the design to reduce SNR degradation due to the co-pol coupling.

X-pol coupling can refer the coupling effects experienced by feeds of the dual-polarized antennas 107 used for the orthogonal polarization. FIG. 1 illustrates an example configuration of x-pol coupling. The x-pol coupling can cause issues at the receiving system 108. In some instances, x-pol coupling is random and thereby difficult to account for in design. One limiting factor in x-pol coupling can be the coupling between the orthogonal ports of the same antenna dual-polarized antenna 107.

The signal received by the receiving system 108 can have effective isotropic radiated power (EIRP) associated with both the co-pol and x-pol elements. As noted above, the coupling effects of the antenna array 106 may lower the XPD of receiving system 108, reducing the SNR. In some instances, the XPD will degrade the SNR when both the co-pol and the x-pol are on (e.g., transmitting or receiving signals), relative to when only one of the co-pol and the x-pol are on.

Further, as noted above, the PAs 104 can experience variable impedance (Z) dependent relative magnitude and phase between the signals associated with each polarization is fed into the antenna array 106, which can lead to load-pulling the PAs 104 as the impedance varies for different beam positions. In some implementations, Z depends on the co-pol active return loss (ARL), with random variations due to x-pol coupling effects.

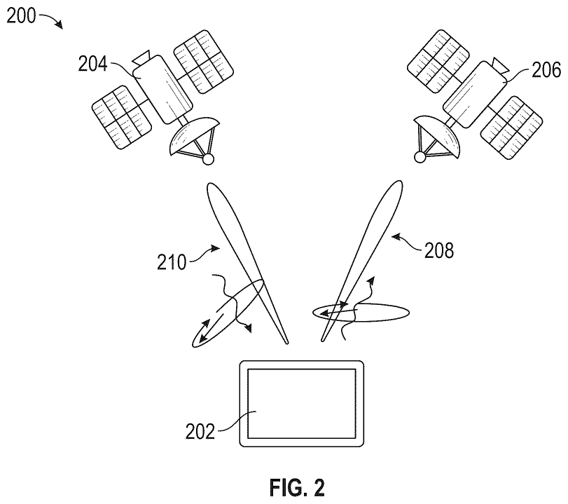

FIG. 2 illustrates one example of the use of a dual-polarized communication device in a satellite communications network 200, also referred to as a Satcom system or Satcom network. The satellite communications network 200 can include a transmitting satellite 204, a receiving satellite 206, and communication device 202. The communication device 202 can be equipped with RF electronics for wirelessly communicating with the transmitting satellite 204 and the receiving satellite 206 using beamforming, such as with an array of dual-polarized antennas and BFICs. The communication device 202 can represent a wide range of terminals in a satellite communications network 200, such as, but not limited to, mobile communications devices, cars, or other terminals. Further, while FIG. 2 illustrates both a receiving satellite 206 and a transmitting satellite 204, in some instances only one satellite may be present, performing some, or all, of the operations of one or both the receiving satellite 206 and a transmitting satellite 204.

In the illustrated embodiment, the communication device 202 transmits uplink (UL) signals 208 to the receiving satellite 206 over a first frequency band and receives downlink (DL) signals 210 from the a transmitting satellite 204 over a second frequency band. Thus, the satellite communications network 200 is dual band, in this example. The satellite communications network 200 can operate with full-duplex communications. The same aperture can be used for concurrently transmitting and receiving radio frequency signals. Advantageously, antennas and antenna arrays disclosed herein can reduce and/or minimize transmit to receive emissions in the satellite communications network 200 with full-duplex communications. Further, in the illustrated embodiment the DL signals 210 may have a first polarization and the UL signals 208 may have a second polarization, orthogonal, or substantially orthogonal, to the first polarization. In one nonlimiting example, the communication device 202 may transmit UL signals 208 in a KA band (approximately 27.5 GHz to 31 GHZ) with a left hand circular polarization (LHCP) and receive DL signals 210 in a K band (approximately 17.4 GHz to 21.2 GHz). However, other transmission and reception configurations may alternatively or additionally be used for the communication device 202. In some implementations, the satellite communications network 200 can also operate with half-duplex.

The satellite communications network 200 of FIG. 2 depicts one example application for the circularly polarized antenna arrays disclosed herein. However, circularly polarized antenna arrays can be used in other applications.

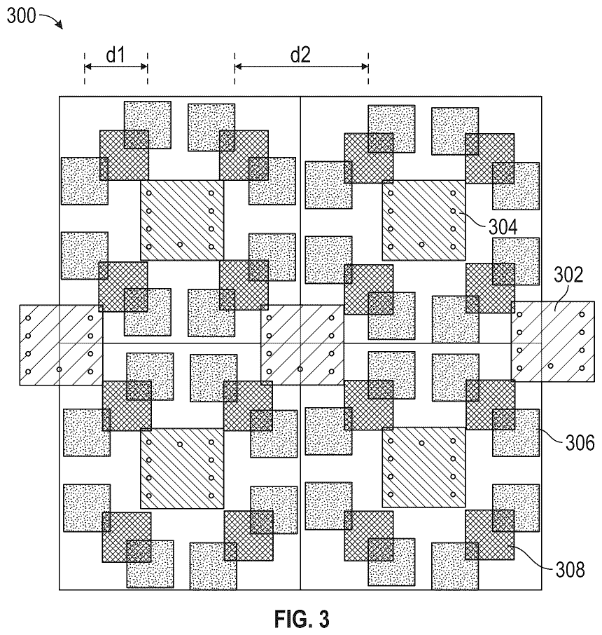

FIG. 3 illustrates a schematic layout diagram of an antenna array 300 that can be used in a dual-polarized communication system, according to various implementations. In some implementations, antenna array 300 can represent one section of an overall antenna array. Is some such implementation, the patterns of antenna array 300 may be repeated in one or more directions to complete the overall antenna array. The antenna array 300 can include a first set of BFICs 302 and a second set of BFICs 304. As illustrated in FIG. 3, the first set of BFICs 302 can be offset from second set of BFICs 304 in one or more directions. The antenna array 300 can also include single feed patches 306 and differential feed patches 308.

In the antenna array 300, the single feed patches 306 have a different polarization than the differential feed patches 308. For instance, the single feed patches 306 can have a left hand circular polarization (LHCP) and the differential feed patches 308 can have a right hand circular polarization (RHCP). As another example, the single feed patches 306 can have a RHCP and the differential feed patches 308 can have a LHCP.

The antenna array 300 can transmit and receive radio frequency signals concurrently on a same aperture. In the illustrated example shown in FIG. 3, single feed patches 306 can be patch antennas used to transmit radio frequency signals and differential feed patches 308 can be patch antennas used to receive radio frequency signals. However, other configurations can be used. For example, some, or all, of the differential feed patched 308 may be used to transmit radio frequency signals and some, or all, of the single feed patches 306 may be used to receive radio frequency signals in some other applications. The transmit radio frequency signal and the receive radio frequency signal can have different frequencies. The differential feed patches 308 can be used for the radio frequency signal with the lower frequency, and the single feed patches 306 can be used for the radio frequency signal with the higher frequency. The BFICs of the first and second sets of BFICs 302 and 304 can be staggered for feeding the single feed patches 306 and differential feed patches 308.

The first set of BFIC 302 and the second set of BFIC 304 may be beamformer circuits used to form and/or control beamform signals, provide signals to antennas, receive signals from antennas, the like, or any combination thereof. The beamformer circuits of the first set of BFICs 302 and/or the second set of BFICs 304 can include all, or a portion, of the features of beamformer circuit 102 discussed above, such as include various PAs, variable gain amplifiers, phase-shifters, low noise amplifiers, the like or any combination thereof. The beamformer circuits of the first set of BFICs 302 and the second set of BFICs 304 can include a number of channels leading to, or coming from, antennas. For example, as illustrated in FIG. 3, each beamformer circuits of the first set of BFIC 302 and the second set of BFIC 304 includes at least eight channels connected to antennas through the differential feed patches 308 or single feed patches 306.

In the illustrated implementation, the first set of BFICs 302 are receive BFICs and the second set of BFICs 304 are transmit BFICs. The transmit BFICs can have transmit circuitry for driving transmit antennas of the antenna array 300, such as the single feed patches 306. Such transmit circuitry can include, but is not limited to, a power amplifier, a phase shifter, and a variable gain circuit (e.g., a variable gain amplifier or variable gain attenuator). The receive BFICs can have receive circuitry for processing radio frequency signals from receive antenna elements of the antenna array 300, such as differential feed patches 308. Such receive circuitry can include, but is not limited to, a low noise amplifier, a phase shifter, and a variable gain circuit (e.g., a variable gain amplifier or variable gain attenuator). In some other implementations the first set of BFICs 302 are transmit BFICs and the second set of BFICs 304 are receive BFICs.

In some implementations, each BFIC of the first set of BFICs 302 can be connected to differential feed patches 308 and each BFIC of the second set of BFICs 304 can be connected to a plurality of single feed patches 306. A BFIC of the first set of BFICs 302 can be connected to any suitable number of differential feed patches 308. For example, a BFIC of the first second of BFICs 302 with N channels can be connected to λ/2 differential feed patches 308, where N is a positive even integer. A BFIC of the second set of BFICs 304 can be connected to any suitable number of single feed patches 306. For example, a BFIC 3 of the second set of BFICs 304 can be connected to one single feed patch 306 for each channel of the BFIC. In some other implementations the first set of BFICs 302 can be connected to single feed patches 306 and the second set of BFICs 304 can be connected to differential feed patches 308. In the illustrated implementation, four differential feed patches 308 are connected to each of BFIC the first set of BFICs 302 and eight single feed patches 306 are connected to each of the second set of BFICs 304. In this implementation, the BFICs of the first set of BFICs 302 can have 8 channels and the BFICs of the second set of BFICs 304 can have 8 channels.

Each of the single feed patches 306 can be connected to a beamformer circuit of the first set of BFICs 302 or the second set of BFICs 304 by way of a single feedline. The single feed patches 306 may be spaced apart by distance d1. In some implementations, distance d1 can be defined by a set wavelength used by the single feed patches 306. Each of the differential feed patches 308 can be connected to dual channels of a beamformer circuit of the first set of BFICs 302 or the second set of BFICs 304 by way of differential feedlines. The differential feedlines can carry a differential signal from a BFIC to a differential feed patch 308. The differential feed patches 308 may be spaced apart by distance d2. In some implementations, distance d2 can be defined by a set wavelength used by the differential feed patches 308.

In some implementations, the first set of BFICs 302 are receive BFICs, connected to four receiving four differential feed patches 308, and the second set of BFICs 304 are transmit BFICs, each connected to eight transmitting single feed patches 306. In these implementations, a radio frequency signal transmitted from the single path feeds 306 can have a higher frequency that a radio frequency signal received by the differential feed patches 308. In such implementations, distance d1 may be approximated by Equation 3, where λ_{Tx} is the wavelength of transmitted radio frequency signal and distance d2 may be approximated by Equation 4 where λ_{Rx} is the wavelength of received radio frequency signal, with λ_{Rx} being approximately 1.5 times λ_{Tx}. Distance d1 and/or distance d2 may be otherwise defined in some other applications. In some implementations, for example as illustrated in FIG. 3, the antenna array 300 includes twice as many single feed patches 306 as differential feed patches 308.

$$d 1 ∼ 0.85 * {λ}_{Tx} / 2 \qquad ( Equation 3 )$$

$$d 2 = {λ}_{Rx} / 2 \qquad ( Equation 4 )$$

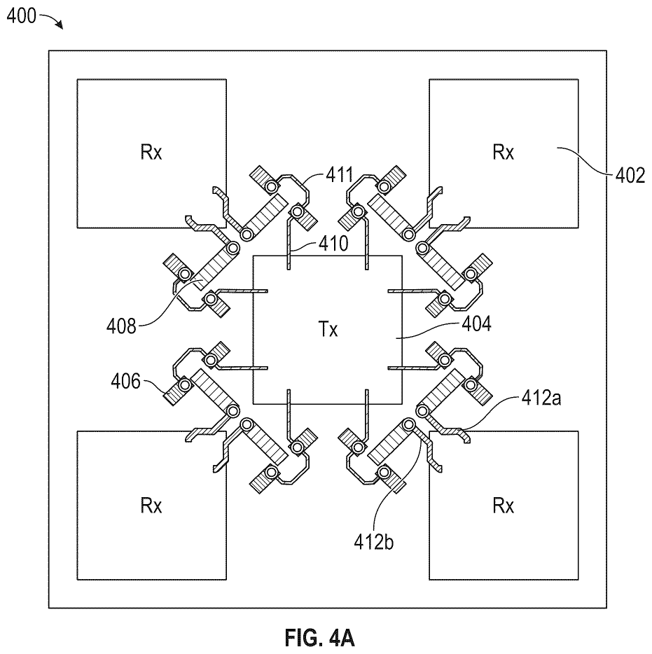

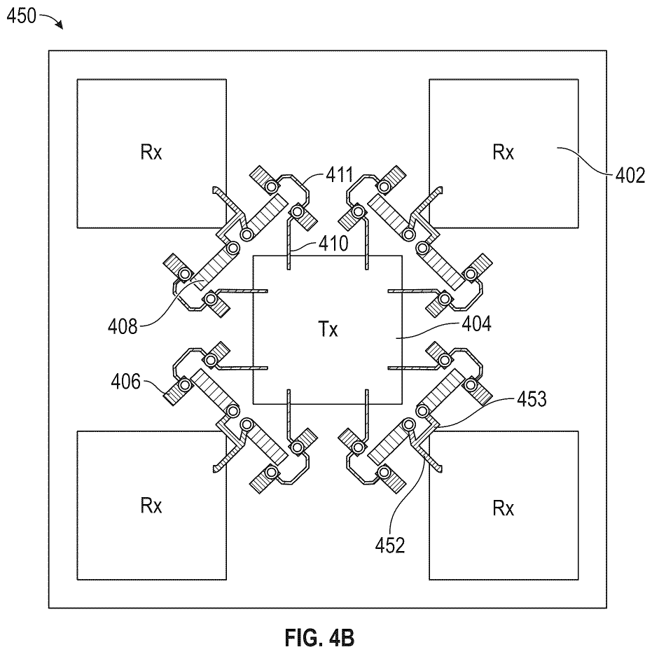

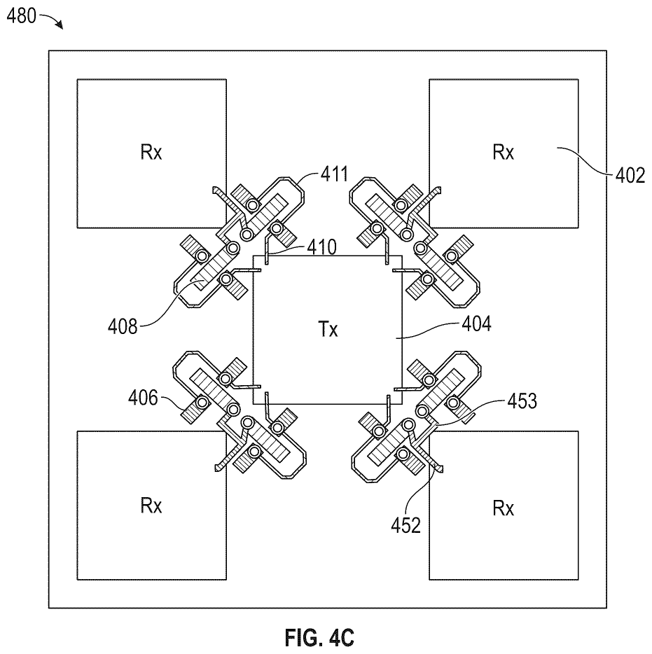

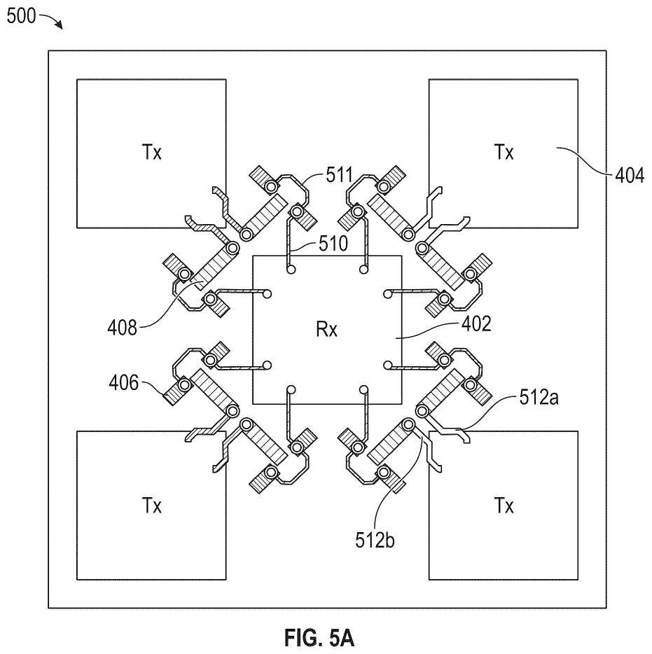

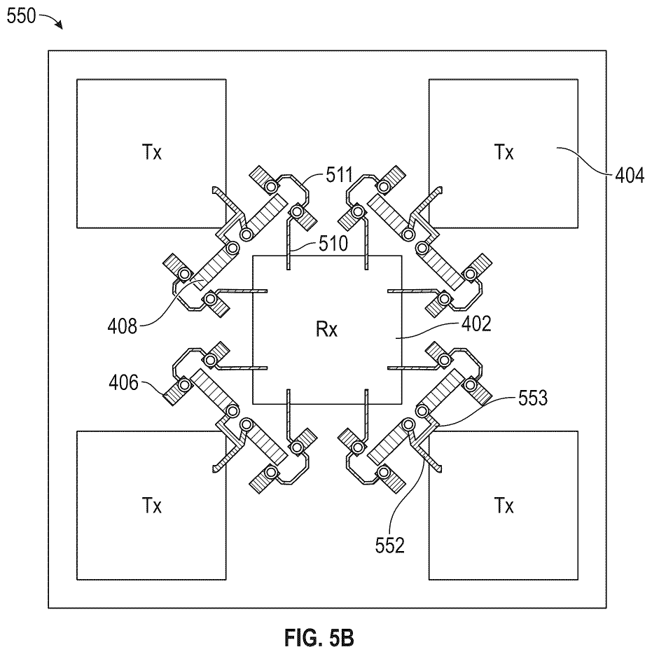

FIGS. 4A-4C, 5A, and 5B illustrate different configurations for a circularly polarized antenna array according to embodiments. The antenna arrays illustrated FIGS. 4A-4C, 5A, and 5B may be used in a dual-polarized communication system, such as dual-polarized communication system 100 of FIG. 1. The antenna arrays illustrated FIGS. 4A-4C, 5A, and 5B may be used in a variety of communication networks, such as the satellite communications network 200 of FIG. 2. The antenna arrays illustrated FIGS. 4A-4C, 5A, and 5B can achieve desirable isolation between orthogonal polarizations and desirable isolation between co-polarizations within the antenna array, which can achieve a relatively stable antenna impedance during a beam scan.

FIG. 4A illustrates antenna array 400, FIG. 4B illustrates antenna array 450, FIG. 4C illustrates antenna array 480, FIG. 5A illustrates antenna array 500, and FIG. 5B illustrates antenna array 550. In various implementations, each of antenna array 400, antenna array 450, antenna array 480, antenna array 500, and antenna array 550 can include one or more transmit (Tx) BFICs 404, one or more receive (Rx) BFICs 402, first dipole antennas 406, and second dipole antennas 408. In the illustrated embodiments, each of the dipole antennas 406 and 408 is a circularly polarized dipole antenna. Each of the dipole antennas 406 and 408 comprise a pair of conductive elements. The pair of conductive elements can be differentially fed. The first dipole antennas 406 can each connect to a BFIC by way of a single feedline, for example, as illustrated in FIG. 4A. The second antennas 408 can each connect to a BFIC by way of two feeds. The second antennas 408 can each connected to a BFIC by way of differential feedlines, for example, as illustrated in FIG. 4A. The antenna array 400, antenna array 450, antenna array 480, antenna array 500, and antenna array 550 each may represent part of one instance of a repeating pattern of a larger antenna array. In the larger array, there can be antennas around each side of most or all of the BFICs of the larger array. In some implementations, the antenna array 400, antenna array 450, antenna array 480, antenna array 500, and antenna array 550 may each include twice as many first dipole antennas 406 as second dipole antennas 408.

The Rx BFICs 402 include receive beamformer circuits. The Tx BFICs 404 include transmit beamformer circuits. The first dipole antennas 406 can be dipole antennas configured to operate (e.g., transmit or receive EM waves) in a first frequency band. The first dipole antennas 406 can have an axial ratio of 3 dB or less in the first frequency band. A first dipole antenna 406 can be geometrically orthogonal with a second dipole antenna 408. As illustrated, a longer dimension of conductive elements of a first dipole antenna 406 can extend in a direction that is orthogonal to a second direction along which a longer dimension of a second dipole antenna 408 extends. As illustrated in FIGS. 4A to 5B, two first dipole antennas 406 can be geometrically orthogonal with second dipole antenna 408 adjacent to opposite ends of the second dipole antenna 408. Orthogonal as used herein can encompass slight variations from exactly orthogonal that achieve substantially the same functionality.

The second dipole antennas 408 can be dipole antennas configured to operate in a second frequency band. The second dipole antennas 408 can have an axial ratio of 3 dB or less in the second frequency band. The second antennas 408 can have a different polarization than the first antennas 406, where one type of antenna has a RHCP and the other type of antenna has a LHCP. In some implementations, the first dipole antennas 406 are configured to operate in the K band and the second dipole antennas 408 are configured to operate in the KA band (e.g., the dipole antennas 406 and dipole antennas 408 have appropriate dipole lengths for the respective frequency bands). In some implementations, the dipole antennas 406 and/or 408 are configured to operate in the E band with an operating frequency in a frequency range from 60 GHz to 90 GHz. In some embodiments, the first dipole antennas 406 and/or the second dipole antennas 408 may be implemented using microstrip dipoles.

In the antenna arrays 400, 450, 500, 550, antennas can transmit and receive radio frequency signals concurrently. For example, in some instances, the first dipole antennas 406 can transmit while the second dipole antennas 408 receive. According to some other instances, the first dipole antennas 406 can receive while the second dipole antennas 408 transmit.

As illustrated in FIGS. 4A-4C, 5A, and 5B, the first dipole antennas 406 and the second dipole antennas 408 may be positioned on a 45 degree axis relative to edges of the Rx BFICs 402 and edges of the Tx BFICs 404. Each dipole antenna, such as a first dipole antenna 406 or second dipole antenna 408, may be placed on a respective axis, such that the nearest dipole antenna 406 and the nearest dipole antenna 408 are oriented orthogonally to the dipole antenna.

In the antenna arrays 400 and 450, the first dipole antennas 406 are transmit antennas and the second dipole antennas 408 are receive antennas. The first dipole antennas 406 can transmit while the second dipole antennas 408 receive in the antenna arrays 400 and 450. The first dipole antennas 406 can operate in a higher frequency band than the second dipole antennas 408 in the antenna array 400 and/or 450.

Referring to FIG. 4A, the antenna array 400 includes a Tx BFIC 404 connected to the first dipole antennas 406 using feedlines 410. Each of the illustrated first dipole antennas 406 is connected to the Tx BFIC 404 by way of a single feedline 410. Each first dipole antenna 406 can include a half wavelength delay line 411 between the poles of the antenna. The half wavelength delay line 411 can delay the signal received from the Tx BFIC 404 by half a wavelength. The half wavelength delay line 411 can provide a 180 degree phase rotation. As such, the first dipole antennas 406 can each operate using a single channel of the Tx BFIC 404 and have a differential input. The antenna array 400 also illustrates Rx BFICs 402 connected to the second dipole antennas 408 using differential feedlines 412a and 412b. Each of the differential feedlines 412a and 412b connect one dipole of a second dipole antenna 408 to a Rx BFIC 402. The Rx BFICs 402 can use phase shifters to offset signals received through each pair of the differential feedlines 412a and 412b. As such, the second dipole antennas 406 can each operate using two channels of an Rx BFIC 402.

Referring to FIG. 4B, the antenna array 450 includes a Tx BFIC 404 connected to the first dipole antennas 406 in the same matter as the antenna array 400. The antenna array 450 is similar to the antenna array 400, except that the antenna array 450 includes the Rx BFICs 402 with different connections to the second dipole antennas 408. The Rx BFICs 402 are connected to the second dipole antennas 408 using feedlines 452 and half wavelength delay lines 453. The half wavelength delay line 453 can delay a signal received by a pole of a second dipole antenna 408 by a half wavelength (or 180 degrees) relative to the other pole of the second dipole antenna 408. As such, the second dipole antennas 408 of antenna array 450 can operate using a single channel of a connected Rx BFIC 402 and be differentially fed.

Referring to FIG. 4C, the antenna array 480 is similar to the antenna array 450 of FIG. 4B, except the first dipole antennas 406 are positioned geometrically orthogonal and adjacent to the center of respective conductive elements of the second dipole antennas 408. The positional relationship of the first dipole antennas 406 and the second dipole antennas 408 illustrated in FIG. 4C may be implemented in an antenna array in accordance with any suitable principles and advantages disclosed herein. Further, other positional configurations of geometrically orthogonal first dipole antennas 406 and second dipole antennas 408 may be implemented in an antenna array in accordance with any suitable principles and advantages disclosed herein. [0096] The antenna array 500 is similar to the antenna array 400 except there are different connections between the BFICs and the dipole antennas. In the antenna array 500, the Rx BFIC 402 is connected to second dipole antennas 408 and the Tx BFICs 404 are connected to first dipole antennas 406.

Referring to FIG. 5A, the antenna array 500 includes an Rx BFIC 402 connected to the first dipole antennas 406 using feedlines 510. Each first dipole antenna 406 can include a half wavelength delay line 511 between the poles of the antenna. The half wavelength delay line 511 can delay the signal received from by a pole of the dipole antenna 406 by half of a wavelength (or 180 degrees). As such, the dipole antennas 406 can each operate using a single channel of the Rx BFIC 402 and be differentially fed. The antenna array 500 also illustrates Tx BFICs 404 connected to the dipole antennas 408 using differential feedlines 512a and 512b. Each of the differential feedlines 512a and 512b connect one pole of a dipole antenna 408 to a Tx BFIC 404. The Tx BFICs 404 can use phase shifters to offset signals received through each of the differential feedlines 512a and 512b. As such, the dipole antennas 406 can each operate using two channels from a Tx BFIC 402.

In the antenna arrays 500 and 550, the first dipole antennas 406 are receive antennas and the second dipole antennas 408 are transmit antennas. The first dipole antennas 406 can receive while the second dipole antennas 408 transmit receive in the antenna arrays 500 and 550. The first dipole antennas 406 can operate in a higher frequency band than the second dipole antennas 408 in the antenna array 500 and/or 550.

The antenna array 550 is similar to the antenna array 450 except there are different connections between the BFICs and the dipole antennas. In the antenna array 550, the Rx BFIC 402 is connected to second dipole antennas 408 and the Tx BFICs 404 are connected to first dipole antennas 406.

Referring to FIG. 5B, the antenna array 550 includes an Rx BFIC 402 connected to the first dipole antennas 406 in the same matter as in the antenna array 500. The antenna array 550 is similar to the antenna array 500, except that the antenna array 550 includes the Tx BFICs 404 connected to the second dipole antennas 408 using feedlines 552 and half wavelength delay lines 553. The half wavelength delay line 553 can delay a signal received from the Tx BFICs 404 by half a wavelength (or 180 degrees). As such, the second dipole antennas 408 of antenna array 550 can operate using a single channel of a connected Tx BFIC 404 and be differentially fed.

In some embodiments, half wavelength delay lines used for signal transmission (e.g. the half wavelength delay line 411 and/or half wavelength delay lines 553) may have a similar length as half wavelength delay lines used for signal reception (e.g., the half wavelength delay lines 511 and/or the half wavelength delay lines 453). In these embodiments, the frequency of transmission and the frequency of reception of the antenna array may be configured such that both the half wavelength delay lines used for signal transmission and the half wavelength delay lines used for reception can delay a signal by half a wavelength (or 180 degrees). For example, if the frequency of reception is approximately three-fifths of the frequency of transmission (f_{Rx}˜3/5*f_{Tx}), then the length (L) of both the half wavelength delay lines used for signal transmission and the half wavelength delay lines used for signal reception are approximated by Equation 5 where λ_{Rx} is the wavelength for signal reception and λ_{Tx} is the wavelength for signal transmission.

$$L ∼ 3 * {λ}_{Rx} / 2 ∼ 5 * {λ}_{Tx} / 2 \qquad ( Equation 5 )$$

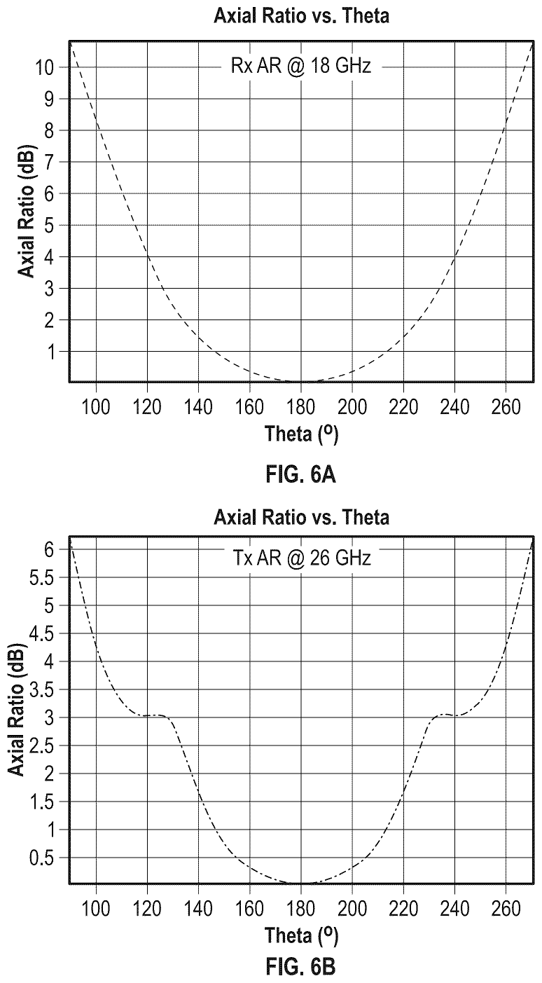

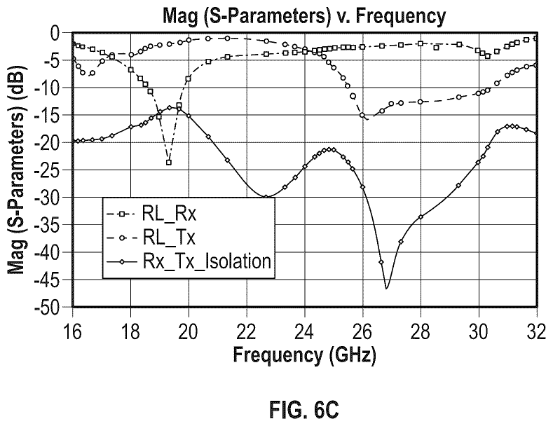

FIGS. 6A-6C are example graphs illustrating various attributes of a circularly polarized antenna array in accordance with one implementation of FIG. 4A. FIG. 6A is a graph of axial ratio versus beam angle (theta) for a circularly polarized antenna array receiving signals at approximately 18 GHz. FIG. 6B is a graph of axial ratio versus beam angle (theta) for a circularly polarized antenna array transmitting signals at approximately 26 GHz. FIG. 6C is a graph of the magnitude of S-parameters versus frequency for a circularly polarized antenna array. S-parameters correspond to reception (Rx), transmission (Tx), an isolation between Rx and Tx signals.

As illustrated in FIGS. 6A-6C, the circularly polarized antenna array exhibits good isolation between Rx and Tx signals, particularly as Rx signals are in the K band and the Tx signals are in the KA band. Further, Rx signals in the K band and Tx signals in the KA band exhibit good axial ratios over a wide scanning range of beam angles.

While some embodiments related to antenna arrays with separate transmit antennas and receive antennas, some embodiments relate to a single antenna element cell. Such a single antenna element cell can include four sequentially rotated conductive elements that form dipoles. The sequentially rotated conductive elements can be connected by quarter wave length delay lines. The single antenna element cell can radiate both RHCP and LHCP signals depending on excitation with high isolation between orthogonal polarizations.

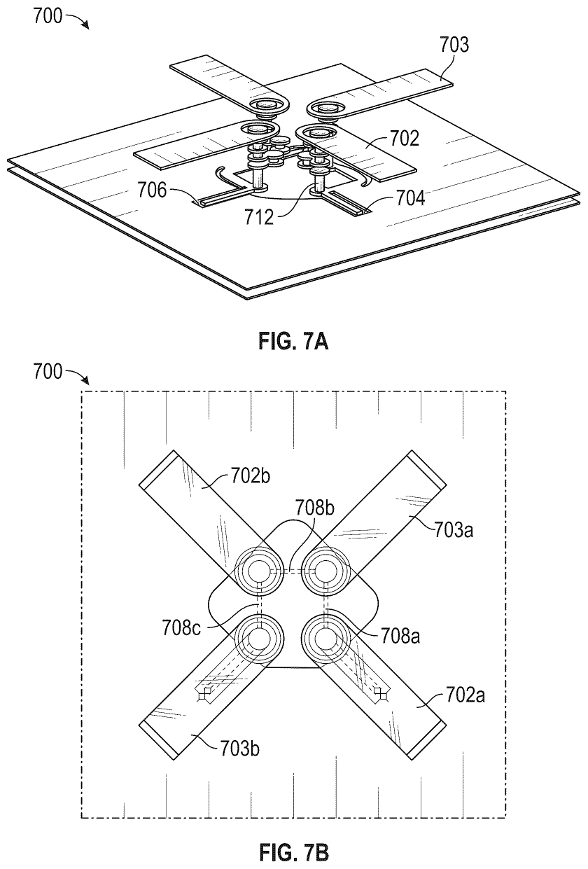

FIGS. 7A and 7B illustrate a single element antenna cell 700 according to an embodiment. The single element antenna cell 700 may be used in either the transmission or reception of circularly polarized radio frequency signals. The single element antenna cell 700 can achieve good isolation due to the geometric arrangement of the dipoles, among other features. The single element antenna cell 700 can include a first dipole 702 with pole 702a and pole 702b, and a second dipole 703 with pole 703a and pole 703b. The first dipole 702 can be orthogonal to the second dipole 703. For example, pole 703a can be 90 degrees rotated compared to pole 702a, pole 702b can be 90 degrees rotated compared to pole 703a, pole 703b can be 90 degrees rotated compared to pole 702b, and pole 702a can be 90 degrees rotated compared to pole 703b.

The poles of the first dipole 702 and the second dipole 703 can be connected by quarter wavelength delay lines 708a-708c. In the illustrated embodiment, pole 702a is connected to pole 703a with a quarter wavelength delay line 708a, pole 703a is connected to pole 702b with a quarter wavelength delay line 708b, and pole 702b is connected to pole 703b with a quarter wavelength delay line 708c. The quarter wavelength delay lines 708a-708c may offset a received signal or signal to be transmitted by a quarter wavelength (λ/4). A quarter wavelength delay can correspond to a 90 degree phase rotation. As such, the signals transmitted or received by pole 702a and pole 702b are offset by a half wavelength (λ/2) or 180 degrees and the signals transmitted or received by pole 703a and pole 703b are offset by λ/2 or 180 degrees.

The single element antenna cell 700 can include a RHCP port 704 and a LHCP port 706. The single element antenna cell 700 can radiate with a RHCP and/or a LHCP. For instance, when the RHCP port 704 is used to transmit, a signal is first fed to the pole 702a, delayed by λ/4 as the signal propagates to the pole 703a, delayed by another λ/4 as the signal propagates from the pole 703a to the pole 702b, and delayed by another λ/4 as the signal propagates from the pole 702b to the pole 703b. The inverse can occur with the RHCP port 704 is used to receive a signal. In another instance, when the LHCP port 706 is used to transmit, a signal is first fed to the pole 703b, delayed by λ/4 as the signal propagates to the pole 702b, delayed by another λ/4 as the signal propagates from the pole 702b to the pole 703a, and delayed by λ/4 as the signal propagates from the pole 703a to the pole 702a. The inverse can occur with the LHCP port 706 is used to receive a signal. Connectors 712 can be used to physically and electrically couple the poles 702a, 702b, 703a, and 703b, to the RHCP port 704, the LHCP port 706, and/or the delay lines 708a-708c.

Both the RHCP port 704 and the LHCP port 706 can be used to transmit signals simultaneously. The RHCP and LHCP signals can both be within the same frequency band for transmit. Similarly, both the RHCP port 704 and the LHCP port 706 can be used to receive signals simultaneously. The RHCP and LHCP signals can both be within the same frequency band for receive.

In an example embodiment, the single element antenna cell 700 includes a first conductive element (e.g., pole 702a); a second conductive element (e.g., pole 703a) rotated 90 degrees relative to the first conductive element, the second conductive element connected to the first conductive element by way of a first quarter wave length delay line (e.g., quarter wavelength delay line 708a); a third conductive element (e.g., pole 702b) rotated 90 degrees relative to the second conductive element, the third conductive element connected to the second conductive element by way of a second quarter wave length delay line (e.g., quarter wavelength delay line 708b); and a fourth conductive element (e.g., pole 703b) rotated 90 degrees relative to the third conductive element, the fourth conductive element connected to the third conductive element by way of a third quarter wave length delay line (e.g., quarter wavelength delay line 708c). In the example embodiment, the single element antenna cell 700 is configured to radiate both a left hand circularly polarized signal and a right hand circularly polarized signal.

In some implementations of the example embodiment, the left hand circularly polarized signal and the right hand circularly polarized signal are within a common frequency band. The single element antenna cell 700 can have an axial ratio of no greater than 3 decibels in the common frequency band. The single element antenna cell 700 can be configured to concurrently receive the left hand circularly polarized signal and the right hand circularly polarized signal. The single element antenna cell 700 can be configured to concurrently transmit the left hand circularly polarized signal and the right hand circularly polarized signal. The conductive elements can be formed from and/or include microstrips.

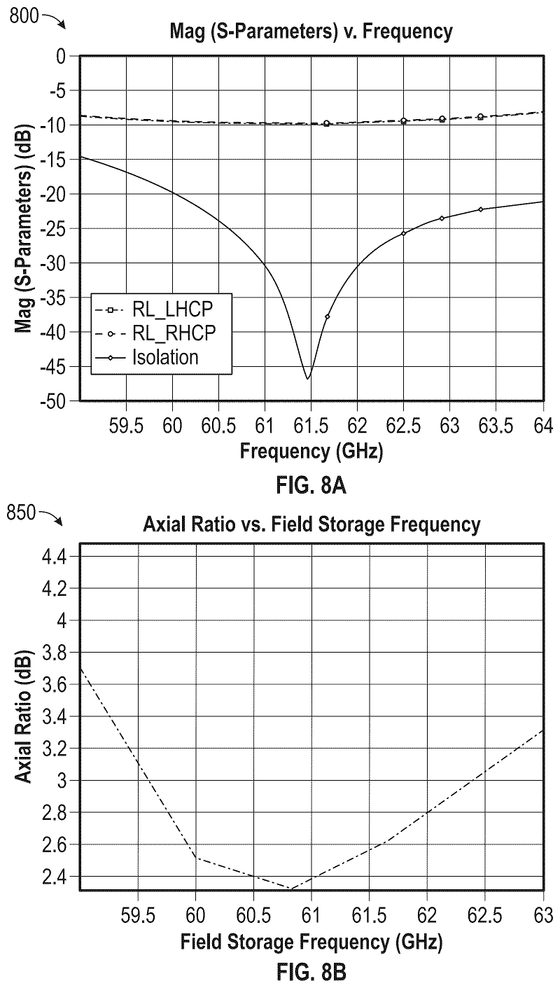

FIGS. 8A and 8B are example graphs illustrating attributes of a single element antenna cell 700 according to an embodiment of FIGS. 7A and 7B. FIG. 8A is a graph of the magnitude of S-parameters versus frequency for a single element antenna cell 700 according to an embodiment. S-parameters correspond to LHCP signals, RHCP signals, and isolation between LHCP signals and RHCP signals. FIG. 8A indicates desirable isolation between LCHP and RHCP signals in an operating band. FIG. 8B is a graph of axial ratio versus frequency for a single element antenna cell 700 according to an embodiment. As illustrated in FIGS. 8A and 8B, the single element antenna cell 700 exhibits good isolation and axial ratios across an operating band.

Antenna apparatus disclosed herein can be implemented in any suitable application that can benefit from a circularly polarized antenna and/or full-duplex wireless communication. Any suitable principles and advantages disclosed herein can be implemented in systems, apparatus, and in methods that include a circularly polarized antenna. The principles and advantages described herein can be implemented in various apparatuses. Examples of such apparatuses can include, but are not limited to, consumer electronic products, parts of the consumer electronic products, electronic test equipment, vehicular electronic products, industrial electronic products, communications infrastructure such as wireless communications infrastructure, etc. Electronic products can include, but are not limited to, wireless communication devices, a mobile phone (for example, a smart phone), a hand-held computer, a tablet computer, a laptop computer, a wearable computing device, a vehicular electronics system, a radio, a wearable health monitoring device, base stations such as cellular base stations, access points, repeaters, relays, etc. Further, apparatuses can include unfinished products.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to.” The words “coupled” or connected “, as generally used herein, refer to two or more elements that may be either directly connected, or connected by way of one or more intermediate elements. Thus, although the various schematics shown in the figures depict example arrangements of elements and components, additional intervening elements, devices, features, or components may be present in an actual embodiment (assuming that the functionality of the depicted circuits is not adversely affected). Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a measurement error.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states.

The teachings of the embodiments provided herein can be applied to other systems, not necessarily the systems described above. The elements and acts of the various embodiments described above can be combined to provide further embodiments. The acts of any methods discussed herein can be performed in any order as appropriate. Moreover, the acts of any methods discussed herein can be performed serially or in parallel, as appropriate.

While certain embodiments of the inventions have been described, these embodiments have been presented by way of example only, and are not intended to limit the scope of the disclosure. Indeed, the novel circuits, methods, and systems described herein may be embodied in a variety of other forms. Furthermore, various omissions, substitutions and changes in the form of the circuits, methods, apparatus and systems described herein may be made without departing from the spirit of the disclosure. For example, while the disclosed embodiments are presented in given arrangements, alternative embodiments may perform similar functionalities with different components and/or circuit topologies, and some elements may be deleted, moved, added, subdivided, combined, and/or modified. Each of these elements may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure. Accordingly, the scope of the present inventions is defined by reference to the claims.

Although the claims presented here are in single dependency format for filing at the USPTO, it is to be understood that any claim may depend on any preceding claim of the same type except when that is clearly not technically feasible.

What is claimed is:

1. An antenna cell comprising:
a first circularly polarized dipole antenna comprising a first pair of differently fed conductive elements, the first circularly polarized dipole antenna being right hand circularly polarized; and
a second circularly polarized dipole antenna comprising a second pair of differently fed conductive elements, the second circularly polarized dipole antenna being left hand circularly polarized,
wherein the first circularly polarized dipole antenna and the second circularly polarized dipole antenna are geometrically orthogonal and configured to operate concurrently, and wherein the first circularly polarized dipole antenna is positioned adjacent to the second circularly polarized dipole antenna.

2. The antenna cell of claim 1, wherein the first circularly polarized dipole antenna and the second circularly polarized dipole antenna are configured to receive concurrently.

3. The antenna cell of claim 1, wherein the first circularly polarized dipole antenna is configured to transmit a right hand circularly polarized signal while the second circularly polarized dipole antenna transmits a left hand circularly polarized signal.

4. The antenna cell of claim 1, wherein the first circularly polarized dipole antenna and the second circularly polarized dipole antenna operate in a common frequency band.

5. The antenna cell of claim 4, wherein the first circularly polarized dipole antenna and the second circularly polarized dipole antenna each have an axial ratio of no greater than 3 decibels in the common frequency band.

6. The antenna cell of claim 1, wherein a conductive element of the first pair of differentially fed conductive elements is connected to each of the conductive elements of the second pair of differentially fed conductive elements by way of a respective quarter wavelength delay line.

7. The antenna cell of claim 1, further comprising 3 quarter wavelength delay lines connecting respective adjacent conductive elements of the first and second pairs of differentially fed conductive elements.

8. An antenna cell comprising:
four sequentially rotated conductive elements comprising a first pair of conductive elements forming a first dipole antenna and a second pair of conductive elements forming a second dipole antenna, the first dipole antenna having a right hand circular polarization, and the second dipole antenna having a left hand circular polarization; and
three quarter wavelength delay lines that connect respective adjacent conductive elements of the four sequentially rotated conductive elements such that the first dipole antenna and the second dipole antenna are each differentially fed.

9. The antenna cell of claim 8, wherein the first dipole antenna and the second dipole antenna operate in a common frequency band.

10. The antenna cell of claim 9, wherein the first dipole antenna and the second dipole antenna each have an axial ratio of no greater than 3 decibels in the common frequency band.

11. The antenna cell of claim 8, wherein the antenna cell is configured to concurrently receive a left hand circularly polarized signal and a right hand circularly polarized signal.

12. The antenna cell of claim 8, wherein the antenna cell is configured to concurrently transmit a left hand circularly polarized signal and a right hand circularly polarized signal.

13. The antenna cell of claim 8, wherein the four sequentially rotated conductive elements comprise microstrips.

14. The antenna cell of claim 8, further comprising:
a first port configured to feed a left hand circularly polarized signal, the first port connected to a conductive element of the first pair of conductive elements; and
a second port configured to feed a right hand circularly polarized signal, the second port connected to a conductive element of the second pair of conductive elements.

15. A method of wireless communication, the method comprising:
transmitting a right hand circularly polarized signal from a first dipole antenna of an antenna cell; and
concurrent with the transmitting right hand circularly polarized signal, transmitting a left hand circularly polarized signal from a second dipole antenna of the antenna cell;
wherein the antenna cell comprises:
four sequentially rotated conductive elements comprising a first pair of conductive elements forming the first dipole antenna and a second pair of conductive elements forming the second dipole antenna; and
three quarter wavelength delay lines that connect respective adjacent conductive elements of the four sequentially rotated conductive elements such that the first dipole antenna and the second dipole antenna are each differentially fed.

16. The method of claim 15, wherein the first dipole antenna and the second dipole antenna operate in a common frequency band.

17. The method of claim 15, wherein the four sequentially rotated conductive elements comprise microstrips.

18. The method of claim 15, wherein the right hand circularly polarized signal and the left hand circularly polarized signal each have a frequency in a range from 15 gigahertz to 100 gigahertz.

19. The method of claim 15, wherein the left hand circularly polarized signal is in either a K band or a KA band.

20. The method of claim 15, wherein the right hand circularly polarized signal is transmitted to a satellite.
